(19) United States
(12) Patent Application Publication
(10) Pub. No.: US 2009/0261022 A1
(43) Pub. Date: Oct. 22, 2009

(54) SYSTEM, METHODOLOGY, AND PRODUCT TO SORT, ORGANIZE, AND STORE TOY BUILDING/CONSTRUCTION SETS

(75) Inventor: AKSHAY SRIVATSAN, Palo Alto, CA (US)

Correspondence Address: AKSHAY SRIVATSAN, 379 SAN ANTONIO RD, PALO ALTO, CA, 94306, US

(73) Assignee: AKSHAY SRIVATSAN, Palo Alto, CA (US)

(21) Appl. No.: 12/416,861

(22) Filed: Apr. 1, 2009

Related U.S. Application Data
(60) Provisional application No. 61/046,743, filed on Apr. 21, 2008.

(51) Int. Cl. B07B 1/00; B07B 1/12; B07B 1/28; A47B 81/00; A47B 96/00

(52) U.S. Cl. 209/2; 312/210.5; 209/680; 209/235

(57) ABSTRACT

A system, methodology, and product to sort, organize and store individual members of building/construction toy sets utilizing a multi-level system of bins with sieves at different heights using user applied forces and gravity to automatically sort and organize pieces into bins, while providing a fun hands-on sorting experience for kids. The location, size and shape of the sieves can be designed to optimize sorting speed and user experience for specific toy manufacturer brands including Lego™ bricks made by Lego Corporation. The system also functions as a storage unit for the pieces, during and after sort. A flexible binding mechanism holds the system together during sort. The system is designed with see-through materials to monitor the status of the sort and find specific pieces in respective bins. A set of wheels enables mobility. The “hands-on” involvement in sorting also makes this an entertaining and educational apparatus for kids.

### CROSS-REFERENCE TO RELATED APPLICATIONS

This application claims priority from U.S. Provisional Patent Application Ser. No. 61/046,743 entitled SYSTEM, METHODOLOGY, AND PRODUCT TO SORT, ORGANIZE, AND STORE TOY BUILDING/CONSTRUCTION SETS filed on Apr. 21, 2008 which is hereby incorporated by reference as if set forth in full in this application for all purposes.

### STATEMENT REGARDING FEDERALLY SPONSORED RESEARCH OR DEVELOPMENT

Statement as to rights to inventions made under federally sponsored research and development—NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

The present invention relates generally to a system, a methodology, and a product to sort, organize and store toy building/construction sets comprising a plurality of building members of different shapes, weights, sizes. More particularly, this invention can be applied to sorting, organizing and storing of the individual members of construction toys. Such toys are very popular in the marketplace and sold under brand names including Lego, K-nex, Tyco and others. We will refer to such toys as Lego toys or construction toys or building toys or building/construction toys in the rest of the document.

Kids (and several adults) like playing and building structures using Lego blocks, bricks and pieces. Building with Lego blocks is fun for kids. Kids, as they grow, like to build more complex structures that require a large number of pieces spanning multitudes of shapes, sizes and weights and their Lego collection expands. As the structures become more complex and the collections become large, it becomes more difficult for kids to find the right pieces of required sizes, shapes or weights for their next build. This results in a more messy playing environment and more time spent in sorting or finding individual pieces for their next build vs. using the time to actually “build” their next construction set.

As such, what is needed is an efficient system, methodology and a product that enables kids to sort, organize and store the individual Lego pieces spanning a wide variety of sizes, shapes and weights in a way that significantly reduces the time it requires for them to find the pieces for their next build and enables them to organize and store the pieces between builds.

### SUMMARY OF THE INVENTION

This invention discloses a system, methodology, and product to sort, organize and store individual pieces of building/construction sets utilizing a multi-level system of bins with sieves at different heights. The system utilizes a combination of gravitational force on the individual pieces and manual forces applied by the user on the system to automatically sort and organize pieces in to the respective bins. The location, size and shape of the sieves in each bin can be chosen to optimize for sorting speed and user experience for specific brands including Lego, K-nex and Tyco. Each bin and its system of sieves is designed and constructed in a way that allows for specific sizes, shapes and weights to filter through to the next level, resulting finally in a set of sorted pieces at different levels. In addition, the size of the individual bins is selected so the system also functions as a storage unit for the pieces, during and after the sort. A flexible binding mechanism (such as one using Velcro and tape) holds the system together during sort while allowing kids to have hands on fun and experience the sorting process. The system is designed with see-through, semi-transparent or transparent, lightweight materials to monitor the status of the sort, look for specific pieces in the respective bins. A set of wheels enables mobility of the unit. The hands-on experience that kids get in sorting through shaking/rolling/swaying and finding their required pieces also makes this system a uniquely entertaining and educational apparatus for kids.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1A-1C schematically illustrate the front view, top view and side-view of the apparatus utilizing the methodology and a specific method for sorting, organizing and storing pieces in the construction toys from Lego in accordance with one embodiment of the present invention.

FIG. 2A-2D schematically illustrates the design of holes in individual sieves for sorting, organizing and storing pieces in the construction toys from Lego in accordance with another embodiment of the present invention.

FIG. 3A-3D schematically illustrates the design of individual sieves for sorting, organizing and storing pieces in the construction toys from Lego in accordance with yet another embodiment of the present invention.

### DESCRIPTION OF THE INVENTION

The invention claimed here enables kids and adults to rapidly sort, find, organize, store, and access individual members of a broad family of toys that enable construction of different shapes and sizes using individual members as building blocks. The methodology, methods and product described here pertain to an integrated modular system with sort, store, organize and access capabilities across multitude of individual members of different shapes, sizes and weights through a system of multi-level bins, each with a unique number, size and location of holes that allow for combining the natural force of gravity with user applied forces to allow each user to tailor their own experience. The integrated design includes mechanisms for safe operation and transport of the integrated mechanism.

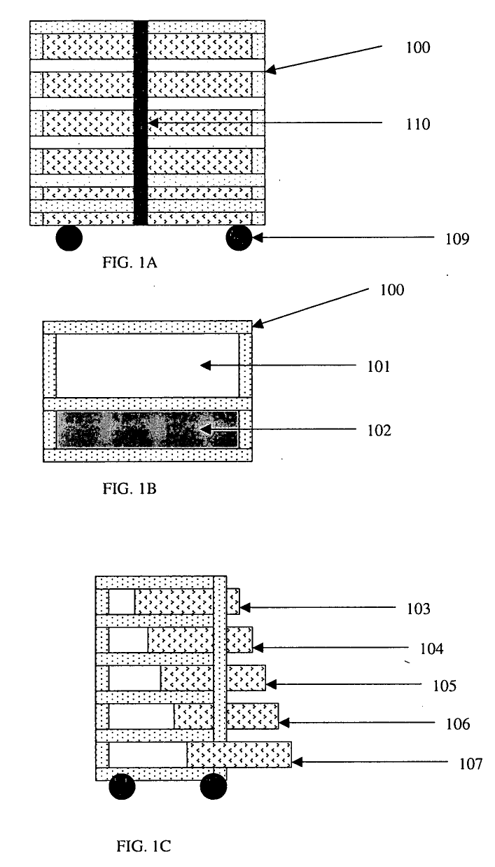

FIG. 1A illustrates a schematic of the front view of the prototype product LEG-O-RGANIZER 100 designed utilizing the methodology and a specific method for sorting, organizing and storing pieces in the construction toys from Lego in accordance with one embodiment of the present invention.

FIG. 1B illustrates the top view of schematic of the prototype product LEG-O-RGANIZER 100 designed utilizing the methodology and a specific method for sorting, organizing and storing pieces in the construction toys from Lego in accordance with one embodiment of the present invention.

FIG. 1C illustrates the side view of the schematic of the prototype product LEG-O-RGANIZER 100 designed utilizing the methodology and a specific method for sorting, organizing and storing pieces in the construction toys from Lego in accordance with one embodiment of the present invention.

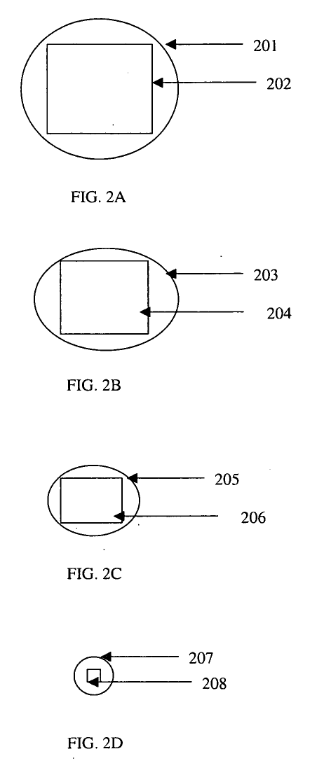

LEG-O-RGANIZER 100 comprises of a five-level bin system made of a lightweight see-through material and mounted on 4 wheels. Each of the five individual bins can be independently pulled out or pushed in. The top surface of the LEG-O-RGANIZER 100 is flat and made of a sturdy material. There is a large opening 101 on the top surface to introduce multiple new members simultaneously into the sorting system. There is a flat surface 102 which can be used to display and hold assembled construction toys. The system of stackable bins 103-107 are made of lightweight transparent material to hold and store sorted individual members. Additional bins can be added to expand the unit. Each bin has a set of round sieves as shown in FIG. 2A-2D. The size of the sieves is selected to allow only certain sizes to pass through while retaining larger sizes in the bin. The sort is done through a manual force of rolling, shaking or twisting the unit, which forces pieces in each bin to move towards the sieves and cause certain pieces to fall through sieves enabling the sort. As the system undergoes more shakes, rolls and twists, more pieces get sorted until eventually all pieces are sorted into the right bins. The smallest pieces fall into the lowest bin, the largest are retained in the highest bin and other bins contain pieces of specific size ranges depending on the size of the sieves. Each bin is detachable and can be pulled out like a drawer or completely taken out of the unit and thus allows the user to store the sorter pieces within the sorter system or in the bin that can then be placed elsewhere. The system is mounted on wheels 109 that allow it to be wheeled away and stored at a convenient place. A detachable binding tape 110 holds the bins in place during sort and can be detached once the sort is completed. In the prototype of LEG-O-RGANIZER 100, a Velcro tape functioned as a detachable binding tape.

FIG. 2A-2D schematically illustrates the design of holes in individual sieves for sorting, organizing and storing pieces in the construction toys from Lego in accordance with another embodiment of the present invention.

FIG. 2A shows the design of hole 201 in sieve for a 4*4 Lego brick 202 to filter through to next level. In addition to 4*4 brick, the holes let 1*1, 1*2, 1*3, 1*4, 2*1, 2*2, 2*3, 2*4, 3*1, 3*2, 3*3, 3*4, 4*1, 4*2, 4*3 bricks and any Lego brick smaller than a 4*4 brick also to filter through.

FIG. 2B shows the design of hole 203 in sieve for a 3*3 Lego brick 204 to filter through to next level. In addition to 3*3 brick, the holes let 1*1, 1*2, 1*3, 2*1, 2*2, 2*3, 3*1, 3*2 bricks and any Lego brick smaller than a 3*3 brick also to filter through.

FIG. 2C shows the design of hole 205 in sieve for a 2*2 Lego brick 206 to filter through to next level. In addition to 2*2 brick, the holes let 1*1, 1*2 bricks and any Lego brick smaller than a 2*2 brick also to filter through.

FIG. 2D shows the design of holes 207 in sieve for a 1*1 Lego brick 208 to filter through to next level.

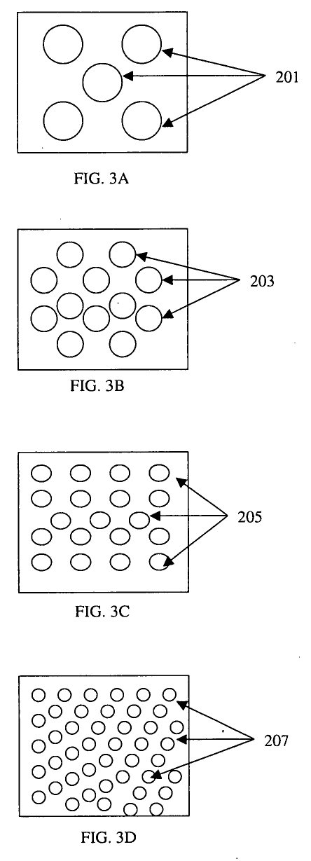

FIG. 3A-3D schematically illustrates the design of individual sieves for sorting, organizing and storing pieces in the construction toys from Lego in accordance with yet another embodiment of the present invention.

FIG. 3A shows the design of sieve with holes for topmost bin as shown in FIG. 2A. The holes let 1*1, 1*2, 1*3, 1*4, 2*1, 2*2, 2*3, 2*4, 3*1, 3*2, 3*3, 3*4, 4*1, 4*2, 4*3, 4*4 bricks and any Lego brick smaller than a 4*4 brick also to filter through to lower level. The Lego bricks bigger that the 4*4 brick are collected and stored in the topmost bin.

FIG. 3B shows the design of sieve with holes as shown in FIG. 2B. The holes let 1*1, 1*2, 1*3, 2*1, 2*2, 2*3, 3*1, 3*2, 3*3 bricks and any Lego brick smaller than a 3*3 brick also to filter through to lower level. The Lego bricks 4*1, 4*2, 4*3 and 4*4 are collected and stored in this bin.

FIG. 3C shows the design of sieve with holes as shown in FIG. 2C. The holes let 1*1, 1*2, 2*1, 2*2 bricks and any Lego brick smaller than a 2*2 brick also to filter through to lower level. The Lego bricks 3*1, 3*2, and 3*3 are collected and stored in this bin.

FIG. 3D shows the design of sieve with holes as shown in FIG. 2D. The holes let 1*1 bricks and any Lego brick smaller than a 1*1 brick also to filter through to lower level. The Lego bricks 2*1, and 2*2 are collected and stored in this bin.

The 1*1 Lego bricks filter through and are collected and stored in the lowermost bin.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method to sort, organize and store individual members in the family of building/construction toys resulting in a set of sorted members, the individual members comprising a multitude of shapes, sizes and weights, the method comprising:
a multi-level system of bins used for the sort;
each system of bins in a multitude of shapes and heights;
each multi-level system of bins with a modular assembly to allow increase or decrease in the number of bins, each individual bin comprising multiple sieves;
the location, size, and shape of sieves in each individual bin chosen to allow only pieces smaller than a particular size to filter to the next level;
a detachable binding mechanism to hold the multi-level system of bins together during the sorting process and that detaches after sort to allow access to individual bins;
the location, size and shape of the sieves in each bin and across the multi-level bin system designed to allow optimization for different sort speeds, different sizes of individual members, quantity and shapes of individual members and for different sorting precision;
the multi-level system of bins mounted on set of wheels for mobility; and
wherein a multitude of manual forces including rolling, shaking, swaying combined applied by kids and adults combines with the natural gravitational force caused by the mass of individual members to create an user interactive sort experience.

2. The method of claim 1, wherein individual members being sorted are Lego™ bricks made by Lego Corporation.

3. The method of claim 1, wherein the multi-level system of bins can be used as a sorting mechanism and as a storage unit before, during and after the sort.

4. The method of claim 1, where the flat top surface of the multi-level system of bins is also a stand for holding assembled “construction toys”.

5. The method of claim 4, wherein the top surface of the multi-level system of bins has a large hole/opening to allow introduction of multiple unsorted members of different shapes, sizes and weights simultaneously.

6. The method of claim 1, wherein the modular stacked bin assembly allows customization of number of bins and a multitude of bin shapes and heights.

7. The method of claim 6, wherein the multi-level system of bins is re-configured to do a fast sort for a specific sizes of members in a selected bin by removing some bins above the selected bin.

8. The method of claim 1, wherein the detachable binding mechanism holds the system of bins together during sort to prevent individual bins from sliding/dropping off during sort and can be detached to allow access the bins.

9. The method of claim 2, wherein the members in one or more bins are visible at any time allowing fast search for specific members.

10. The method of claim 2, wherein the shape of holes in the design of each individual sieve is round or circular.

11. The method of claim 10, wherein the size of holes in each individual sieve is chosen to restrict only pieces that need to be sorted and stored in that bin while allowing smaller sizes to pass through to lower bins.

12. The method of claim 10, wherein the number, size and location of holes in each individual sieve is customized to optimize for different sorting speeds, bin material and sort precision which for instance could be varied by varying the range of pieces that are designed to be collected in any particular bin.

13. The method of claim 1, wherein the largest pieces are collected and stored in the top-most bin, the smallest pieces filter through and are collected/stored in lower-most bin and wherein the size of the pieces stored in each bin is in decreasing order.

14. The method of claim 2, wherein the diameter of the hole in the topmost bin is longer than the diagonal of the 4*4 brick, the diameter of the hole in the second bin is shorter than the diagonal of the 4*4 brick and longer than the diagonal of the 3*3 brick, the diameter of the hole in the third bin is shorter than the diagonal of a 3*3 brick and longer than the diagonal of the 2*2 brick, the diameter of the hole in the fourth bin is shorter than the diagonal of the 2*2 brick and longer than the diagonal of the 1*1 brick and the lowermost bin has no holes.

15. The method of claim 1, wherein the number of holes in any bin is equal or higher than the number of holes in all bins above it and less than or equal to the number of holes in any bin below it and lowermost bin has no holes.

16. The method of claim 2, wherein individual bins can be “pulled out” like drawers.

17. An apparatus to sort, organize and store individual members in the family of building/construction toys resulting finally in a simultaneous set of sorted members that can be accessed independently, the individual members comprising a multitude of shapes, sizes and weights, the method comprising:
a multi-level system of bins;
each system of bins in a multitude of shapes and heights;
each multi-level system of bins with a modular assembly to allow increase or decrease in the number of bins, each individual bin comprising multiple sieves;
the location, size, and shape of sieves in each individual bin chosen to allow only pieces smaller than a particular size to filter to the next level;
a flexible detachable binding mechanism holding the multi-level system of bins together during the sorting process and detaching after sort to allow access to individual bins;
the location, size and shape of the sieves in each bin and across the multi-level bin system designed to allow optimization for different sort speeds, different sizes of individual members, quantity and shapes of individual members and for different sorting precision;
the multi-level system of bins mounted on set of wheels for mobility; and
wherein a multitude of manual forces including rolling, shaking, swaying combined applied by kids and adults combines with the natural gravitational force caused by the mass of individual members to create an user interactive sort.

18. The apparatus of claim 17, wherein individual members being sorted include Lego™ bricks made by Lego Corporation.

19. The apparatus of claim 17, wherein individual bins can be “pulled out” like drawers for easy access to specific size construction set pieces after the sort.

20. The apparatus of claim 17, wherein the material of the bin is lightweight transparent, semi-transparent or see-through to enable user to observe/monitor the sort during sorting and kids or adults to conduct the sort.
